(19) United States
(12) Patent Application Publication
(10) Pub. No.: US 2026/0084504 A1
(43) Pub. Date: Mar. 26, 2026

(54) VEHICLE FRAME STRUCTURE

(71) Applicants: TOYOTA JIDOSHA KABUSHIKI KAISHA, Toyota-shi (JP); SUBARU CORPORATION, Tokyo (JP)

(72) Inventors: Akihito SASAKI, Toyota-shi (JP); Yuji Saito, Tokyo (JP); Tatsunari Imazato, Tokyo (JP); Shota Kiyozumi, Tokyo (JP)

(73) Assignees: TOYOTA JIDOSHA KABUSHIKI KAISHA, Toyota-shi (JP); SUBARU CORPORATION, Tokyo (JP)

(21) Appl. No.: 19/288,050

(22) Filed: Aug. 1, 2025

(30) Foreign Application Priority Data
Sep. 25, 2024 (JP) 2024-166679

(51) Int. Cl. B60J 7/043

(52) U.S. Cl. CPC B60J 7/043

(57) ABSTRACT

A vehicle frame structure includes a pair of side rails extending in a vehicle front-rear direction on both sides of a roof opening in a vehicle width direction, a plurality of cross members extending in the vehicle width direction and joining the side rails to each other, and a pair of reinforcing members extending in the vehicle front-rear direction on both sides of the roof opening in the vehicle width direction and disposed on an inner side relative to the side rails in the vehicle width direction. Each reinforcing member includes a plurality of coupling portions extending in the vehicle width direction and coupling the reinforcing member and the cross members to each other.

### CROSS-REFERENCE TO RELATED APPLICATION

This application claims priority to Japanese Patent Application No. 2024-166679 filed on Sep. 25, 2024. The disclosure of the above-identified application, including the specification, drawings, and claims, is incorporated by reference herein in its entirety.

### BACKGROUND

### 1. Technical Field

A technology disclosed by the present specification relates to a vehicle frame structure.

### 2. Description of Related Art

In Japanese U.S. Pat. No. 7,473,018 (JP 7473018 B), a vehicle sunroof structure including a front sunroof and a rear sunroof is disclosed. The sunroof structure in JP 7473018 B includes a pair of side rails that extends in the vehicle front-rear direction on both sides of the sunroof in the vehicle width direction, and a plurality of cross members that extends in the vehicle width direction and joins the side rails to each other. The sunroof structure in JP 7473018 B further includes an opening reinforcement coupled to side members.

### SUMMARY

In the sunroof structure in JP 7473018 B, it is conceived that the strength decreases when the opening area of the sunroof is increased. When the strength of the sunroof structure decreases, there is a risk of the vehicle easily being deformed at the time of a collision. Thus, the present specification provides a technology of reducing the deformation of a vehicle at the time of a collision while increasing the opening area of a roof opening portion.

A first aspect of the present technology relates to a vehicle frame structure of a vehicle including a roof opening portion. The vehicle frame structure includes a pair of side rails extending in a vehicle front-rear direction on both sides of the roof opening in a vehicle width direction, a plurality of cross members extending in the vehicle width direction and configured to join the side rails to each other, and a pair of reinforcing members extending in the vehicle front-rear direction on both sides of the roof opening in the vehicle width direction and disposed on an inner side relative to the side rails in the vehicle width direction. Each of the reinforcing members includes a plurality of coupling portions extending in the vehicle width direction and configured to couple the reinforcing member and the cross members to each other.

With the configuration above, as a result of including the reinforcing members, it becomes possible to maintain the strength of the vehicle frame structure even when the opening area of the roof opening portion is increased. As a result of each of the reinforcing members including the coupling portions extending in the vehicle width direction, it becomes possible to efficiently transmit the load applied to the vehicle between the reinforcing members and the cross members.

In a second aspect, in the first aspect, the reinforcing member may include a plurality of bent portions bent in the vehicle up-down direction.

In a third aspect, in the first or second aspect, the vehicle frame structure may further include a center pillar extending in the vehicle up-down direction and configured to support the side rail. The cross members may include a front cross member disposed on the front side relative to the center pillar, and a rear cross member disposed on the rear side relative to the center pillar. The roof opening portion may be provided between the front cross member and the rear cross member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle of an embodiment;

FIG. 2 is a perspective view showing a part of a vehicle frame structure of the embodiment;

FIG. 3 is an upper view showing a part of the vehicle frame structure of the embodiment;

FIG. 4 is a sectional view taken along line IV-IV in FIG. 3; and

FIG. 5 is a lower view showing a part of the vehicle frame structure of the embodiment.

### DETAILED DESCRIPTION OF EMBODIMENTS

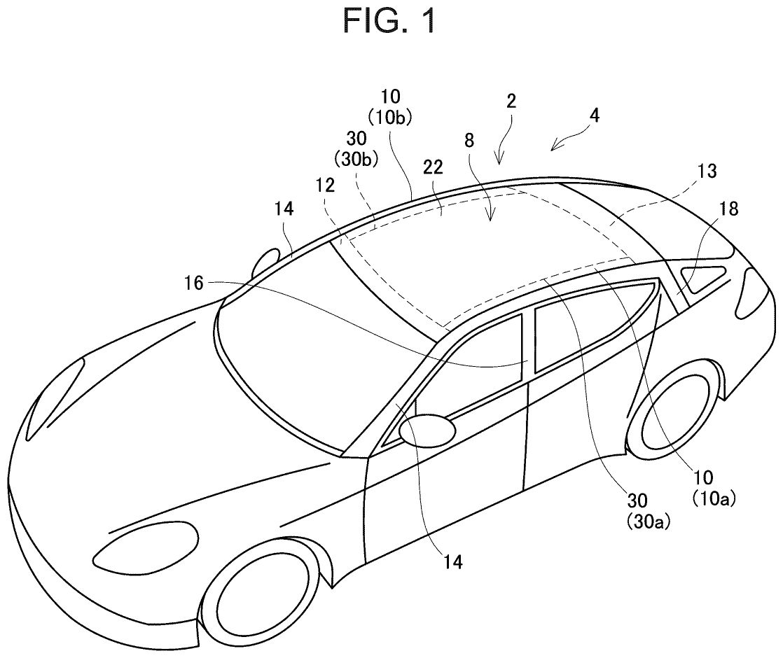

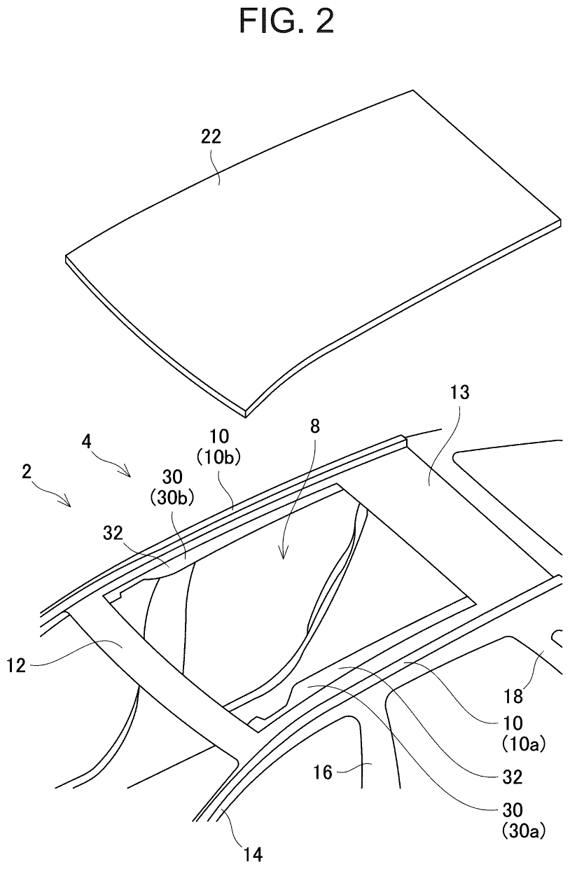

A vehicle frame structure 2 of an embodiment is described with reference to the drawings. The vehicle frame structure 2 of the embodiment has a structure serving as a frame of a vehicle 4 as shown in FIG. 1 and FIG. 2. The type of the vehicle 4 is not particularly limited but may be a gasoline vehicle, a hybrid electric vehicle, or a battery electric vehicle, for example.

The vehicle 4 includes a roof glass panel 22. The roof glass panel 22 configures a roof of the vehicle 4. The roof glass panel 22 is mounted on an upper portion of the vehicle frame structure 2 and covers the upper portion of the vehicle frame structure 2. The roof glass panel 22 is mounted on the vehicle frame structure 2 via a sealing member such as a weatherstrip, for example.

The vehicle frame structure 2 has a function of supporting the load applied to the vehicle 4. The vehicle frame structure 2 includes a pair of side rails 10, a plurality of cross members (a front cross member 12 and a rear cross member 13), a pair of front pillars 14, a pair of center pillars 16, and a pair of rear pillars 18. The vehicle frame structure 2 includes a pair of reinforcing members 30. The vehicle frame structure 2 may further include structure members other than the above.

The vehicle frame structure 2 includes a roof opening portion 8. The roof opening portion 8 is configured by a region surrounded by the side rails 10, the front cross member 12, and the rear cross member 13. The side rails 10, the front cross member 12, and the rear cross member 13 configure a frame of the roof opening portion 8. The roof opening portion 8 is covered with the roof glass panel 22. The roof opening portion 8 may also be called a sunroof.

One of the side rails 10 of the vehicle frame structure 2 is disposed in the vehicle 4 on its right side in the width direction (vehicle width direction) of the vehicle 4, and the other of the side rails 10 of the vehicle frame structure 2 is disposed in the vehicle 4 on its left side in the width direction (vehicle width direction) of the vehicle 4. The side rails 10 are disposed to be spaced apart from each other in the vehicle width direction. One of the side rails 10 is disposed on the right side of the roof opening portion 8 in the vehicle width direction, and the other of the side rails 10 is disposed on the left side of the roof opening portion 8 in the vehicle width direction. One side rail 10 (left side rail 10a) out of the side rails 10 is disposed on the outer left side of the roof opening portion 8 in the vehicle width direction (the left-right direction of the vehicle 4), and the other side rail 10 (right side rail 10b) is disposed on the outer right side of the roof opening portion 8 in the vehicle width direction.

Each of the right and left side rails 10 extends in the length direction (vehicle front-rear direction) of the vehicle 4. Each side rail 10 is supported by the front pillar 14, the center pillar 16, and the rear pillar 18. Each side rail 10 is spanned across the front pillar 14, the center pillar 16, and the rear pillar 18. Each side rail 10 is produced so as to be integral with the front pillar 14, the center pillar 16, and the rear pillar 18.

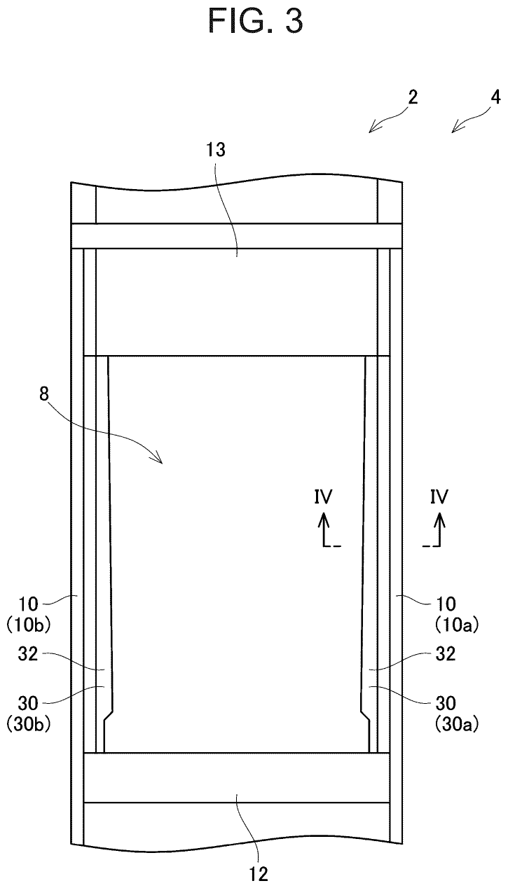

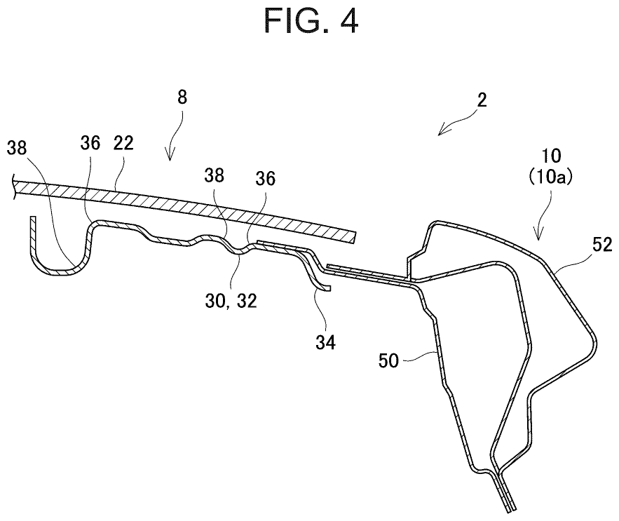

As shown in FIG. 3 and FIG. 4, the side rail 10 includes an inner panel 50 and an outer panel 52 when a section orthogonal to the vehicle front-rear direction is seen. The inner panel 50 is disposed on the vehicle inner side, and the outer panel 52 is disposed on the vehicle outer side. The side rail 10 is configured as a result of coupling the inner panel 50 and the outer panel 52 to each other by joining through welding, for example.

As shown in FIG. 1 to FIG. 4, the front cross member 12 and the rear cross member 13 are disposed to be spaced apart from each other in the vehicle front-rear direction. Other cross members are not disposed between the front cross member 12 and the rear cross member 13. The roof opening portion 8 is provided between the front cross member 12 and the rear cross member 13. The front cross member 12 and the rear cross member 13 face each other over the roof opening portion 8. The cross members 12, 13 are disposed between the left side rail 10a and the right side rail 10b and join the left side rail 10a and the right side rail 10b to each other. The cross members 12, 13 are coupled to the left side rail 10a and the right side rail 10b.

The cross member 12 is disposed on one side of the roof opening portion 8 in the vehicle front-rear direction, and the cross member 13 is disposed on the other side of the roof opening portion 8 in the vehicle front-rear direction. The front cross member 12 is disposed on the front side of the roof opening portion 8. The front cross member 12 is disposed on the rear side relative to the front pillar 14 and on the front side relative to the center pillars 16. The rear cross member 13 is disposed on the rear side of the roof opening portion 8. The rear cross member 13 is disposed on the rear side relative to the center pillars 16 and is disposed on the front side relative to the rear pillars 18. The width of the rear cross member 13 in the vehicle front-rear direction is wider than the width of the front cross member 12 in the vehicle front-rear direction.

One of the front pillars 14 is disposed in the vehicle 4 on its right side in the vehicle width direction, and the other of the front pillars 14 is disposed in the vehicle 4 on its left side in the vehicle width direction. The front pillars 14 are disposed to be spaced apart from each other in the vehicle width direction. The front pillars 14 are disposed on the front side relative to the front cross member 12. Each of the front pillars 14 is coupled to a corresponding one of the side rails 10. An upper end portion of the front pillar 14 is coupled to a front end portion of the side rail 10. The front pillar 14 is produced so as to be integral with the side rail 10. The front pillar 14 extends in the height direction (up-down direction) of the vehicle 4. The front pillar 14 extends to be diagonal with respect to the vertical direction and the horizontal direction.

The center pillars 16 are disposed on the rear side relative to the front pillars 14. One of the center pillars 16 is disposed in the vehicle 4 on its right side in the vehicle width direction, and the other of the center pillars 16 is disposed in the vehicle 4 on its left side in the vehicle width direction. The center pillars 16 are disposed to be spaced apart from each other in the vehicle width direction. The center pillars 16 are disposed on the rear side relative to the front cross member 12 and on the front side relative to the rear cross member 13. Each of the center pillars 16 is coupled to a corresponding one of the side rails 10. An upper end portion of the center pillar 16 is coupled to a central portion of the side rail 10 in the front-rear direction. The center pillar 16 is produced so as to be integral with the side rail 10. The center pillar 16 extends in the height direction (up-down direction) of the vehicle 4.

The rear pillars 18 are disposed on the rear side relative to the center pillars 16. One of the rear pillars 18 is disposed in the vehicle 4 on its right side in the vehicle width direction, and the other of the rear pillars 18 is disposed in the vehicle 4 on its left side in the vehicle width direction. The rear pillars 18 are disposed to be spaced apart from each other in the vehicle width direction. The rear pillars 18 are disposed on the rear side relative to the rear cross member 13. Each of the rear pillars 18 is coupled to a corresponding one of the side rails 10. An upper end portion of the rear pillar 18 is coupled to a rear end portion of the side rail 10. The rear pillar 18 is produced so as to be integral with the side rail 10. The rear pillar 18 extends in the height direction (up-down direction) of the vehicle 4. The rear pillar 18 extends to be diagonal with respect to the vertical direction and the horizontal direction.

One of the reinforcing members 30 is disposed in the vehicle 4 on its right side in the vehicle width direction, and the other of the reinforcing members 30 is disposed in the vehicle 4 on its left side in the vehicle width direction. The reinforcing members 30 are disposed to be spaced apart from each other in the vehicle width direction. One of the reinforcing members 30 is disposed on the right side of the roof opening portion 8 in the vehicle width direction, and the other of the reinforcing members 30 is disposed on the left side of the roof opening portion 8 in the vehicle width direction. One reinforcing member 30 (left reinforcing member 30a) out of the reinforcing members 30 is disposed on the outer left side of the roof opening portion 8 in the vehicle width direction, and the other reinforcing member 30 (right reinforcing member 30b) is disposed on the outer right side of the roof opening portion 8 in the vehicle width direction. The reinforcing members 30 are disposed on the inner side relative to the side rails 10 in the vehicle width direction. Each of the reinforcing members 30 is coupled to a corresponding one of the side rails 10 by joining through welding, for example.

The reinforcing members 30 are disposed between the front cross member 12 and the rear cross member 13 in the vehicle front-rear direction. The right and left reinforcing members 30 extend in the vehicle front-rear direction along the right and left side rails 10. The reinforcing member 30 includes a main body portion 32, a front coupling portion 40, and a rear coupling portion 42.

The main body portion 32 extends in the vehicle front-rear direction. The main body portion 32 extends from a place on the front side relative to the center pillar 16 to a place on the rear side relative to the center pillar 16 in the vehicle front-rear direction.

As shown in FIG. 4, the main body portion 32 is configured by a bent plate-like member when a section orthogonal to the vehicle front-rear direction is seen. The main body portion 32 extends in the vehicle width direction while bending on the inner side relative to the side rail 10 in the vehicle width direction. The main body portion 32 is bent at a plurality of parts. The main body portion 32 includes one or a plurality of first bent portions 34 bent upward, one or a plurality of second bent portions 36 bent downward, and one or a plurality of third bent portions 38 bent sideward. The main body portion 32 is disposed so as to cover an end portion of the roof opening portion 8 in the vehicle width direction. The main body portion 32 is disposed so as to cover a lower surface of an end portion of the roof glass panel 22 in the vehicle width direction.

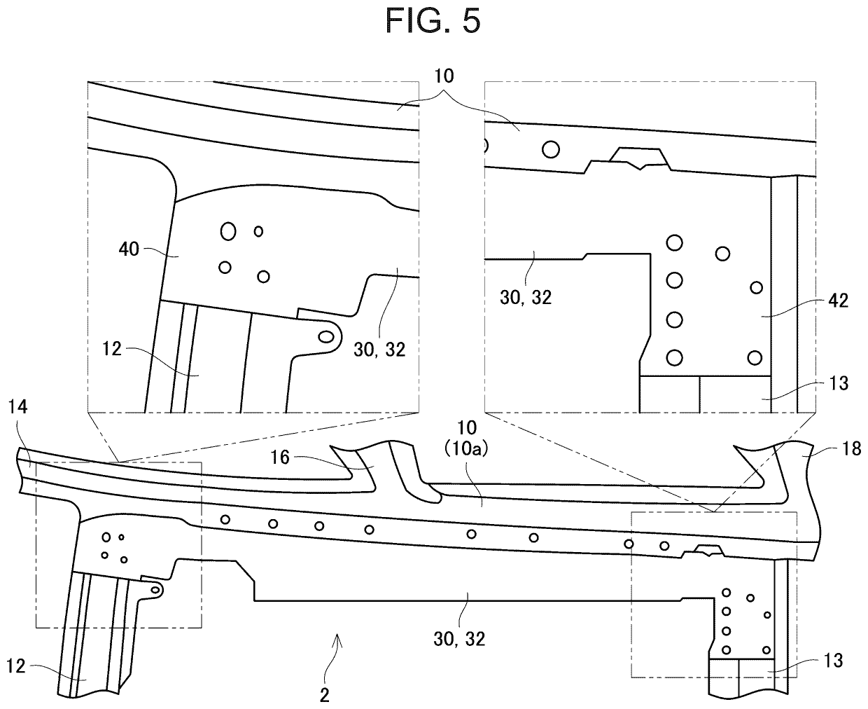

As shown in FIG. 5, the front coupling portion 40 extends from a front end portion of the main body portion 32 toward a place on the inner side in the vehicle width direction. The front coupling portion 40 is joined to the front cross member 12 by joining through welding, for example. The front coupling portion 40 is joined to the front cross member 12 at a plurality of places by welding. In a modified example, the front coupling portion 40 may be joined to the front cross member 12 by fasteners such as bolts.

The rear coupling portion 42 extends from a rear end portion of the main body portion 32 toward a place on the inner side in the vehicle width direction. The rear coupling portion 42 is coupled to the rear cross member 13 by joining through welding, for example. The rear coupling portion 42 is joined to the rear cross member 13 at a plurality of places by welding. In a modified example, the rear coupling portion 42 may be joined to the rear cross member 13 by fasteners such as bolts.

### Effects

The vehicle frame structure 2 of the embodiment has been described above. As is clear from the description above, the vehicle frame structure 2 includes the reinforcing members 30 extending in the vehicle front-rear direction. The reinforcing members 30 have one reinforcing member 30 extending on one side of the roof opening portion 8 in the vehicle width direction and another reinforcing member 30 extending on the other side of the roof opening portion 8 in the vehicle width direction. The reinforcing members 30 are disposed on the inner side relative to the side rails 10 in the vehicle width direction. The reinforcing member 30 includes the coupling portions (the front coupling portion 40, the rear coupling portion 42) configured to couple the reinforcing member 30 and the cross members 12, 13 to each other. The coupling portions (the front coupling portion 40, the rear coupling portion 42) extend in the vehicle width direction.

With the configuration above, as a result of including the reinforcing members 30, it becomes possible to maintain the strength of the vehicle frame structure 2 even when the opening area of the roof opening portion 8 is increased. As a result of each of the reinforcing members 30 including the coupling portions (the front coupling portion 40, the rear coupling portion 42) extending in the vehicle width direction, it becomes possible to efficiently transmit the load applied to the vehicle 4 between the reinforcing members 30 and the cross members 12, 13.

The reinforcing member 30 includes the bent portions 34, 36 bent in the vehicle up-down direction. With the configuration above, it becomes possible to efficiently absorb the energy of the load applied to the vehicle 4 by the reinforcing member 30.

The vehicle frame structure 2 further includes the center pillars 16 configured to support the side rails 10. The center pillars 16 extend in the vehicle up-down direction. The vehicle frame structure 2 includes the front cross member 12 disposed on the front side relative to the center pillars 16, and the rear cross member 13 disposed on the rear side relative to the center pillars 16. The roof opening portion 8 is provided between the front cross member 12 and the rear cross member 13. With the configuration above, it becomes possible to widen the interval between the front cross member 12 and the rear cross member 13 in the vehicle front-rear direction and increase the opening area of the roof opening portion 8.

Although specific examples of the present disclosure have been described above in detail, these are merely exemplifications and do not limit the scope of claims. The technology described in the scope of claims includes embodiments carried out by variously modifying and changing the specific examples exemplified above. The technical elements described in the present specification or the drawings exhibit technical utility by themselves or by various combinations thereof, and are not limited to the combinations described in the claims as originally filed. The technology exemplified in the present specification or the drawings may achieve a plurality of objects at the same time, and has a technical utility by achievement of any one of the objects itself.

What is claimed is:

1. A vehicle frame structure of a vehicle including a roof opening portion, the vehicle frame structure comprising:
a pair of side rails extending in a vehicle front-rear direction on both sides of the roof opening in a vehicle width direction;
a plurality of cross members extending in the vehicle width direction and configured to join the side rails to each other; and
a pair of reinforcing members extending in the vehicle front-rear direction on both sides of the roof opening in the vehicle width direction and disposed on an inner side relative to the side rails in the vehicle width direction,
wherein each of the reinforcing members includes a plurality of coupling portions extending in the vehicle width direction and configured to couple the reinforcing member and the cross members to each other.

2. The vehicle frame structure according to claim 1, wherein the reinforcing member includes a plurality of bent portions bent in a vehicle up-down direction.

3. The vehicle frame structure according to claim 1, further comprising a center pillar extending in a vehicle up-down direction and configured to support the side rail, wherein:
the cross members include a front cross member disposed on a front side relative to the center pillar, and a rear cross member disposed on a rear side relative to the center pillar; and
the roof opening portion is provided between the front cross member and the rear cross member.
